(19) United States
(12) Patent Application Publication
(10) Pub. No.: US 2025/0326440 A1
(43) Pub. Date: Oct. 23, 2025

(54) VEHICLE LOWER STRUCTURE

(71) Applicant: TOYOTA JIDOSHA KABUSHIKI KAISHA, Aichi-ken (JP)

(72) Inventors: Shigeyuki INOUE, Toyota-shi (JP); Naoya KAWAMOTO, Nisshin-shi (JP); Takahito SAKURABA, Seto-shi (JP); Kenichi KAKISHITA, Nagoya-shi (JP); Kohei TAKASE, Susono-shi (JP); Kai MIYAMURA, Toyota-shi (JP); Kazuya KUMAZAWA, Nagoya-shi (JP)

(21) Appl. No.: 19/173,815

(22) Filed: Apr. 9, 2025

(30) Foreign Application Priority Data
Apr. 18, 2024 (JP) 2024-067399

(51) Int. Cl. B62D 21/15; B60K 1/04; B60L 50/60

(52) U.S. Cl. CPC B62D 21/155; B60K 1/04; B60L 50/66

(57) ABSTRACT

A vehicle lower structure includes: a pair of side members; an extending member; a power storage device; and a supported member. The extending member extends from at least one of the pair of side members between the pair of side members. The power storage device is fixed to the pair of side members. The power storage device is disposed below the extending member. The supported member is fixed to an upper portion of the power storage device and supported by the extending member. The power storage device includes a fixation portion. The fixation portion is a portion to which the supported member is fixed such that downward displacement of the fixation portion is suppressed. The supported member is configured such that the fixation portion can be displaced upward.

### CROSS REFERENCE TO RELATED APPLICATIONS

This nonprovisional application is based on Japanese Patent Application No. 2024-067399 filed on Apr. 18, 2024 with the Japan Patent Office, the entire contents of which are hereby incorporated by reference.

### BACKGROUND

### Field

The present disclosure relates to a vehicle lower structure.

### Description of the Background Art

Japanese Patent Laying-Open No. 2020-142589 discloses that a battery pack is disposed on the lower side of a floor panel.

### SUMMARY

In a vehicle lower structure, a power storage device may be fixed to a member located above the power storage device. By doing so, such deformation that the power storage device warps downward due to the weight thereof can be suppressed. However, the above-described member prevents the power storage device from warping upward. Therefore, for example, stress generated in the power storage device due to vibrations when a vehicle including the vehicle lower structure travels cannot be released by warping. As described above, a power storage device in a conventional vehicle lower structure was low in durability.

The present disclosure has been made in view of the above-described problem, and an object of the present disclosure is to provide a vehicle lower structure that can achieve improved durability of a power storage device in the vehicle lower structure.

A vehicle lower structure according to an aspect of the present disclosure includes: a pair of side members; an extending member; a power storage device; and a supported member. The extending member extends from at least one of the pair of side members between the pair of side members. The power storage device is fixed to the pair of side members. The power storage device is disposed below the extending member. The supported member is fixed to an upper portion of the power storage device and supported by the extending member. The power storage device includes a fixation portion. The fixation portion is a portion to which the supported member is fixed such that downward displacement of the fixation portion is suppressed. The supported member is configured such that the fixation portion can be displaced upward.

In the vehicle lower structure according to the aspect of the present disclosure, preferably, the supported member includes: a pillar portion; and a cantilever portion. The pillar portion extends upward from the fixation portion. The cantilever portion extends in a substantially horizontal direction from the pillar portion. The cantilever portion is supported from below by the extending member.

In the vehicle lower structure according to the aspect of the present disclosure, preferably, the supported member may further include a cushion member disposed between the cantilever portion and the extending member.

In the vehicle lower structure according to the aspect of the present disclosure, preferably, the extending member is a cross member extending from one side member to the other side member of the pair of side members.

In the vehicle lower structure according to the aspect of the present disclosure, preferably, the extending member extends from one side member of the pair of side members and is separated from the other side member of the pair of side members. The pillar portion is disposed side by side with the extending member in a vehicle width direction. The cantilever portion extends along an upper surface of the extending member.

In the vehicle lower structure according to the aspect of the present disclosure, preferably, the supported member includes a stretchable portion. The stretchable portion has a variable length. The fixation portion is hung from the extending member by the supported member.

In the vehicle lower structure according to the aspect of the present disclosure, preferably, the supported member is formed of an elastic member. The supported member is sandwiched between the fixation portion and the extending member in an up-down direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view showing a vehicle including a vehicle lower structure according to a first embodiment.

FIG. 2 is a schematic exploded perspective view showing the vehicle lower structure according to the first embodiment.

FIG. 3 is a cross-sectional view of the vehicle lower structure according to the first embodiment when viewed from the front side.

FIG. 4 is a cross-sectional view of the vehicle lower structure in FIG. 3 when viewed in the direction of an arrow IV-IV.

FIG. 5 is an enlarged view of a part of FIG. 4.

FIG. 6 is a cross-sectional view showing a state in which a power storage device has been deformed to warp upward in the vehicle lower structure according to the first embodiment.

FIG. 7 is a partial cross-sectional view showing a vehicle lower structure according to a modification of the first embodiment.

FIG. 8 is a cross-sectional view of a vehicle lower structure according to a second embodiment when viewed from the front side.

FIG. 9 is a cross-sectional view showing a state in which a power storage device has been deformed to warp upward in the vehicle lower structure according to the second embodiment.

FIG. 10 is a partial cross-sectional view showing a vehicle lower structure according to a modification of the second embodiment.

FIG. 11 is a partial cross-sectional view showing a vehicle lower structure according to another modification of the second embodiment.

FIG. 12 is a cross-sectional view of a part of the vehicle lower structure in FIG. 11 when viewed in the direction of an arrow XII-XII.

FIG. 13 is a cross-sectional view showing a vehicle lower structure according to a third embodiment.

FIG. 14 is a cross-sectional view showing a state in which a power storage device has been deformed to warp upward in the vehicle lower structure according to the third embodiment.

FIG. 15 is a cross-sectional view showing a vehicle lower structure according to a fourth embodiment.

FIG. 16 is a cross-sectional view showing a state in which a power storage device has been deformed to warp upward in the vehicle lower structure according to the fourth embodiment.

### DESCRIPTION OF THE PREFERRED EMBODIMENTS

Hereinafter, a vehicle lower structure according to each embodiment of the present disclosure will be described with reference to the drawings. In the following drawings, the same or corresponding portions are denoted by the same reference characters and description thereof will not be repeated.

Arrows F, B, U, D, L, and R in the drawings used in the following description indicate directions with respect to a vehicle, and arrow F indicates a “forward direction”, arrow B indicates a “backward direction”, arrow U indicates an “upward direction”, arrow D indicates a “downward direction”, arrow L indicates a “left direction”, and arrow R indicates a “right direction”.

### First Embodiment

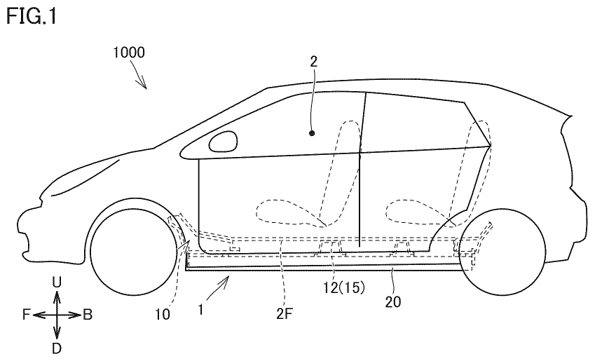

FIG. 1 is a side view showing a vehicle including a vehicle lower structure according to a first embodiment. A vehicle 1000 including a vehicle lower structure 1 according to the first embodiment is, for example, an electrically powered vehicle such as an electric vehicle or a hybrid vehicle that can be driven by a motor. Vehicle 1000 includes a vehicle compartment 2. Vehicle compartment 2 is located above vehicle lower structure 1.

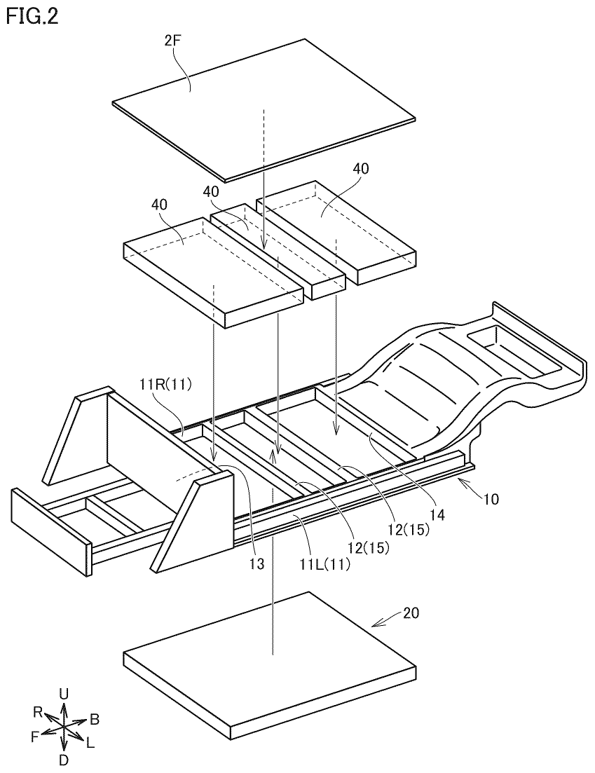

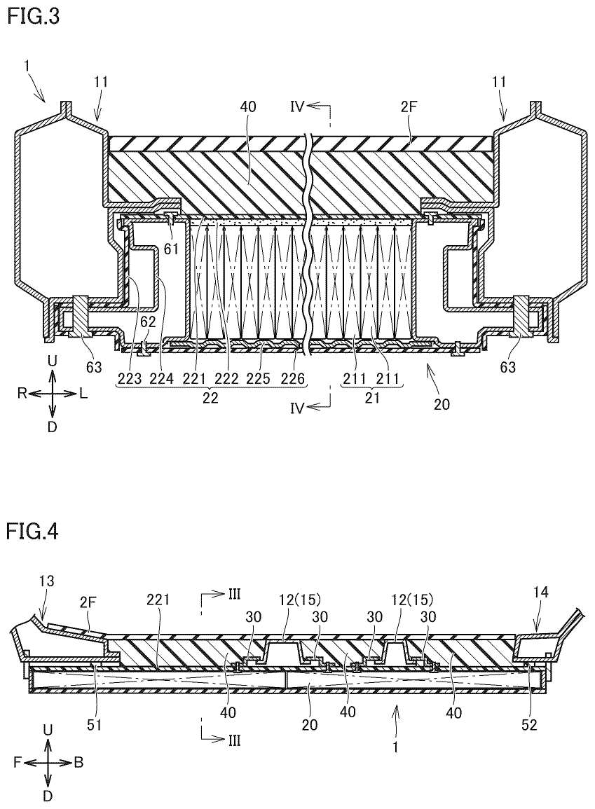

FIG. 2 is a schematic exploded perspective view showing the vehicle lower structure according to the first embodiment. FIG. 3 is a cross-sectional view of the vehicle lower structure according to the first embodiment when viewed from the front side. FIG. 4 is a cross-sectional view of the vehicle lower structure in FIG. 3 when viewed in the direction of an arrow IV-IV. The cross-sectional view when viewed in the direction of an arrow III-III in FIG. 4 corresponds to the cross-sectional view in FIG. 3.

As shown in FIGS. 2 to 4, vehicle lower structure 1 includes a lower frame 10, a power storage device 20 and a supported member 30.

First, lower frame 10 will be described. Lower frame 10 includes a pair of side members 11, one or more cross members 12, a front member 13, and a rear member 14.

The pair of side members 11 extend in a vehicle front-rear direction. The pair of side members 11 are located on both sides of the center of vehicle lower structure 1 in a vehicle width direction. The pair of side members 11 include a left side member 11L and a right side member 11R. Left side member 11L is located on the left side with respect to the center of vehicle lower structure 1 in the vehicle width direction. Right side member 11R is located on the right side with respect to the center of vehicle lower structure 1 in the vehicle width direction.

Each of one or more cross members 12 extends from one side member 11 to the other side member 11 of the pair of side members 11. Each of one or more cross members 12 extends in a direction orthogonal to a direction in which the pair of side members 11 extend. Specifically, each of one or more cross members 12 extends along the vehicle width direction. In the present embodiment, lower frame 10 includes a plurality of cross members 12. The plurality of cross members 12 are spaced apart from each other in the vehicle front-rear direction.

Front member 13 extends in the vehicle width direction. Front member 13 is located forward of the plurality of cross members 12. Front member 13 connects front portions of the pair of side members 11.

Rear member 14 extends in the vehicle width direction. Rear member 14 is located rearward of the plurality of cross members 12. Rear member 14 connects rear portions of the pair of side members 11.

Lower frame 10 further includes a plurality of extending members 15. In the present embodiment, lower frame 10 includes cross members 12 as extending members 15. However, extending members 15 may be included as members different from cross members 12. In this case, extending members 15 may be configured to extend from at least one of the pair of side members 11 between the pair of side members 11.

In the present embodiment, extending members 15 may also have the above-described configuration that cross members 12 have. In addition, in the present embodiment, cross members 12 may have a below-described configuration of extending members 15.

In the present embodiment, the plurality of extending members 15 may have the same configuration. Therefore, a detailed configuration of extending member 15 will be described, while focusing on one extending member 15. FIG. 5 is an enlarged view of a part of FIG. 4. As shown in FIG. 5, extending member 15 has a top plate portion 151, a plurality of wall portions 152 and a plurality of protruding portions 153.

Top plate portion 151 extends in a substantially horizontal direction. The plurality of wall portions 152 extend downward from top plate portion 151. One of the plurality of wall portions 152 extends from a front portion of top plate portion 151. One of the plurality of wall portions 152 extends from a rear portion of top plate portion 151.

Each of the plurality of protruding portions 153 extends from a lower end of a corresponding one of the plurality of wall portions 152 to one side in the vehicle front-rear direction. For example, one protruding portion 153 further extends forward from wall portion 152 extending from the front portion of top plate portion 151. Another protruding portion 153 further extends rearward from wall portion 152 extending from the rear portion of top plate portion 151.

Next, power storage device 20 will be described. Power storage device 20 is fixed to the pair of side members 11 (see FIG. 3). Power storage device 20 is also fixed to front member 13 and rear member 14 (see FIG. 4). Power storage device 20 is not directly fixed to extending members 15.

Power storage device 20 is disposed below extending members 15. Power storage device 20 is disposed below front member 13 and rear member 14.

As shown in FIG. 3, power storage device 20 includes a power storage module 21 and a case 22. Power storage module 21 includes a plurality of power storage cells 211 housed in case 22 and arranged in the substantially horizontal direction. Each of power storage cells 211 is configured to include a battery that stores electric power to be supplied to a motor. The plurality of power storage cells 211 may be stacked in the vehicle width direction, or may be stacked in the vehicle front-rear direction.

Case 22 has an upper plate 221, an adhesive 222, side walls 223, inner walls 224, a support plate 225, and a bottom plate 226. Upper plate 221, a pair of side walls 223 and bottom plate 226 are made of FRP, for example. These members constitute an outer structure of case 22. Adhesive 222, inner walls 224 and support plate 225, and power storage module 21 are disposed in this outer structure.

Power storage module 21 (each of the plurality of power storage cells 211) is joined to upper plate 221 with adhesive 222 interposed therebetween. Inner walls 224 are disposed on both outer sides in the stacking direction of power storage module 21 (the plurality of power storage cells 211). Support plate 225 has a plate-like shape and is disposed between power storage module 21 and bottom plate 226. Inner walls 224 are integrated with upper plate 221 by a fixing tool 61 and are integrated with bottom plate 226 by a fixing tool 62. A surface pressure distribution board that distributes a load from above upper plate 221 in the substantially horizontal direction may be disposed between power storage module 21 and upper plate 221.

Power storage device 20 configured as described above is fastened to the pair of side members 11 in lower frame 10 by a plurality of fastening tools 63. Power storage device 20 is thereby fixed to the pair of side members 11. Seals 51 and 52 may be disposed between power storage device 20 (upper plate 221) and lower frame 10 (front member 13 and rear member 14) (see FIG. 4).

As shown in FIG. 5, power storage device 20 includes a plurality of fixation portions 25. Each of the plurality of fixation portions 25 is a portion to which supported member 30 is fixed. Fixation portions 25 may be located on an upper portion of power storage device 20 and a specific material of fixation portions 25 is not particularly limited. In the present embodiment, fixation portions 25 are a part of upper plate 221 of case 22.

Fixation portions 25 may be an upper portion of power storage module 21. When fixation portions 25 are the upper portion of power storage module 21, openings may be formed in upper plate 221 located above fixation portions 25. When another member such as a surface pressure distribution board is disposed between upper plate 221 and power storage module 21, fixation portions 25 may be the other member.

Next, a plurality of supported members 30 will be described. One supported member 30 will be described below. All of the plurality of supported members 30 may have a configuration described below.

As shown in FIG. 5, supported member 30 is fixed to the upper portion of power storage device 20. In addition, supported member 30 is supported by extending member 15.

Specifically, supported member 30 is fixed to fixation portion 25 of power storage device 20. In the present embodiment, supported member 30 is fixed to upper plate 221. Supported member 30 and fixation portion 25 are fixedly connected to each other by a fixing member 71. Although fixing member 71 is a fastening tool, fixing member 71 may be an adhesive member.

Supported member 30 is located on the outside of extending member 15 in the substantially horizontal direction. In the present embodiment, supported member 30 is located on the front side or the rear side of extending member 15.

Supported member 30 has a pillar portion 31 and a cantilever portion 32. Pillar portion 31 extends upward from fixation portion 25. Pillar portion 31 includes a base portion 311 and a main body portion 312 extending upward from base portion 311. Base portion 311 extends in the substantially horizontal direction. Base portion 311 is in contact with fixation portion 25. Fixing member 71 is connected to base portion 311. Main body portion 312 may have a rod-like outer shape, or may have a plate-like outer shape.

Cantilever portion 32 extends in the substantially horizontal direction from pillar portion 31. Cantilever portion 32 extends in the substantially horizontal direction from an upper end of main body portion 312 of pillar portion 31.

Cantilever portion 32 is supported from below by protruding portion 153 of extending member 15. Cantilever portion 32 is not bonded to extending member 15. When cantilever portion 32 extends rearward, cantilever portion 32 is supported from below by protruding portion 153 protruding forward. When cantilever portion 32 extends forward, cantilever portion 32 is supported from below by protruding portion 153 protruding rearward.

A material of supported member 30 is not particularly limited. Supported member 30 may be made of metal, for example. Supported member 30 may be made of a resin material. Supported member 30 may be made of FRP.

Vehicle lower structure 1 may further include one or more intermediate members 40. Intermediate members 40 are disposed below a floor carpet 2F that constitutes a part of vehicle compartment 2 (see FIGS. 2, 3 and the like). One or more intermediate members 40 are disposed to fill spaces partitioned by the pair of side members 11, one or more cross members 12 (extending members 15), front member 13, and rear member 14. Intermediate members 40 may be made of a material that is lighter and softer than metal. Intermediate members 40 are made of a material including a foaming resin, for example. Although intermediate members 40 may be in contact with supported members 30, intermediate members 40 may be separated from supported members 30.

The function of supported member 30 will now be described. Downward displacement of fixation portion 25 is suppressed by supported member 30 configured as described above. Specifically, cantilever portion 32 is caught by protruding portion 153 of extending member 15 located below cantilever portion 32, whereby downward displacement of fixation portion 25 fixed to supported member 30 is suppressed. On the other hand, however, supported member 30 is configured such that fixation portion 25 can be displaced upward. Thus, power storage device 20 can be deformed to warp upward.

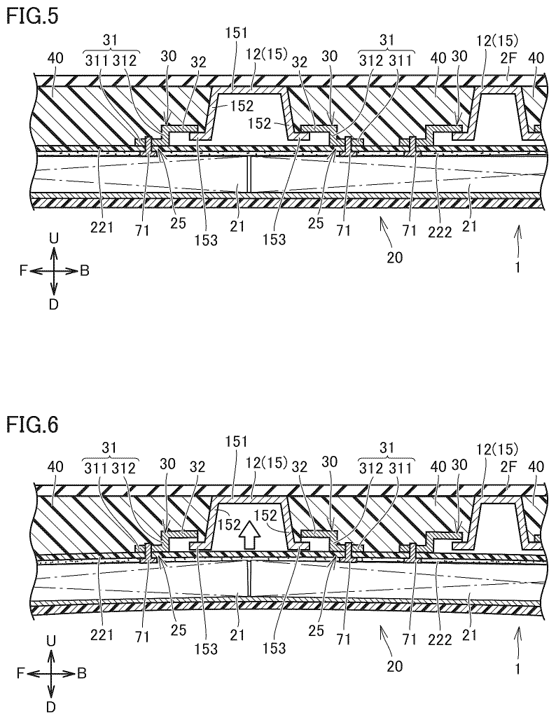

This deformation will be described in more detail. FIG. 6 is a cross-sectional view showing a state in which the power storage device has been deformed to warp upward in the vehicle lower structure according to the first embodiment. FIG. 6 shows a portion corresponding to the portion shown in the cross-sectional view in FIG. 5.

As shown in FIGS. 5 and 6, when stress acts on power storage device 20 due to vibrations and the like generated when vehicle 1000 travels, for example, fixation portion 25 (upper plate 221) tries to be deformed upward. At this time, supported member 30 (cantilever portion 32) is displaced upward to move away from extending member 15 (protruding portion 153). As a result, power storage device 20 can be deformed to warp upward.

As described above, vehicle lower structure 1 includes: a pair of side members 11; extending member 15; power storage device 20; and supported member 30. Extending member 15 extends from at least one of the pair of side members 11 between the pair of side members 11. Power storage device 20 is fixed to the pair of side members 11. Power storage device 20 is disposed below extending member 15. Supported member 30 is fixed to an upper portion of power storage device 20 and supported by extending member 15. Power storage device 20 includes fixation portion 25. Fixation portion 25 is a portion to which supported member 30 is fixed such that downward displacement of fixation portion 25 is suppressed. Supported member 30 is configured such that fixation portion 25 can be displaced upward.

According to the above-described configuration, such deformation that power storage device 20 warps downward due to the weight thereof can be suppressed by supported member 30. On the other hand, supported member 30 can permit power storage device 20 to be deformed to warp upward when vehicle 1000 including vehicle lower structure 1 travels, for example. Therefore, durability of power storage device 20 in vehicle lower structure 1 can be improved.

Furthermore, in vehicle lower structure 1 according to the present embodiment, supported member 30 includes pillar portion 31 and cantilever portion 32. Pillar portion 31 extends upward from fixation portion 25. Cantilever portion 32 extends in the substantially horizontal direction from pillar portion 31. Cantilever portion 32 is supported from below by extending member 15.

According to the above-described configuration, when fixation portion 25 is displaced upward, cantilever portion 32 extending from pillar portion 31 can be displaced upward to move away from extending member 15. Thus, regardless of the material of supported member 30, supported member 30 can permit power storage device 20 to be deformed to warp upward.

Furthermore, in vehicle lower structure 1 according to the present embodiment, extending member 15 is cross member 12 extending from one side member 11 to the other side member 11 of the pair of side members 11.

According to the above-described configuration, rigidity of vehicle lower structure 1 can be increased by cross member 12. Furthermore, since strong cross member 12 supports supported member 30, such deformation that power storage device 20 warps downward due to the weight thereof can be further suppressed.

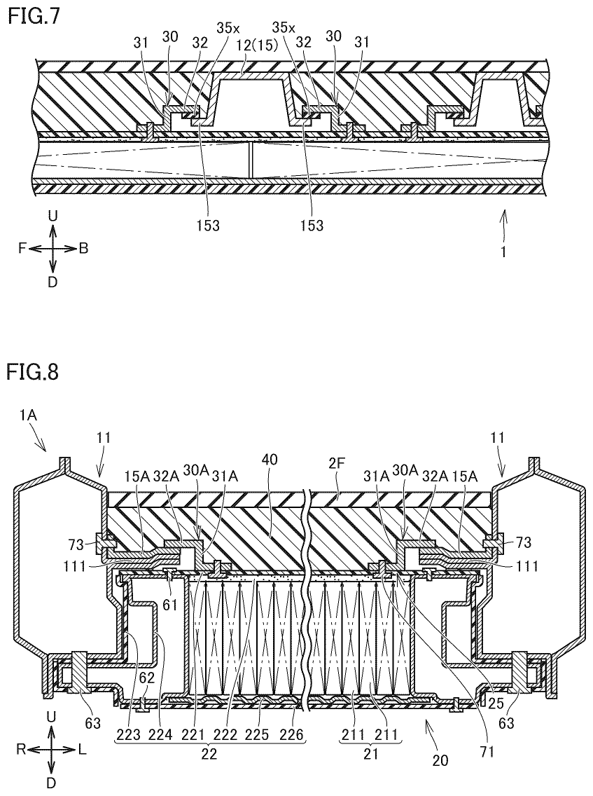

Supported member 30 and extending member 15 do not necessarily need to be in direct contact with each other. FIG. 7 is a partial cross-sectional view showing a vehicle lower structure according to a modification of the first embodiment. FIG. 7 shows a portion corresponding to the portion shown in the cross-sectional view in FIG. 5 in the first embodiment.

As shown in FIG. 7, supported member 30 may further have a cushion member 35x disposed between cantilever portion 32 and extending member 15.

After cantilever portion 32 is displaced upward to move away from extending member 15, cantilever portion 32 is displaced downward and again returns to the state of being supported by extending member 15. At this time, according to the above-described configuration, a load received from cantilever portion 32 by extending member 15 can be reduced by cushion member 35x.

Specifically, cushion member 35x is disposed between cantilever portion 32 and protruding portion 153. Cushion member 35x is formed of a member that is softer than cantilever portion 32 and protruding portion 153. Cushion member 35x may be formed of a rubber member or a foaming resin, for example.

### Second Embodiment

Next, a vehicle lower structure according to a second embodiment of the present disclosure will be described. The vehicle lower structure according to the second embodiment of the present disclosure is different from vehicle lower structure 1 according to the first embodiment of the present disclosure mainly in that an extending member is not a cross member. Description of the same configuration and effect as those of vehicle lower structure 1 according to the first embodiment will not be repeated.

FIG. 8 is a cross-sectional view of the vehicle lower structure according to the second embodiment when viewed from the front side. FIG. 8 shows a portion corresponding to the portion shown in the cross-sectional view in FIG. 3 in the first embodiment.

As shown in FIG. 8, in a vehicle lower structure 1A according to the second embodiment, an extending member 15A extends from one side member 11 of the pair of side members 11 and is separated from the other side member 11 of the pair of side members 11. A pillar portion 31A is disposed side by side with extending member 15A in the vehicle width direction. A cantilever portion 32A extends along an upper surface of extending member 15A.

According to the above-described configuration, regardless of whether vehicle lower structure 1A includes cross member 12, supported member 30A can be supported by extending member 15A.

Extending member 15A is fixed to side member 11 by a fastening tool 73. However, extending member 15A may be formed integrally with a member that constitutes side member 11. For example, extending member 15A may be a flange portion 111 protruding inward in the vehicle width direction in side member 11. In the present embodiment, extending member 15A is located above flange portion 111.

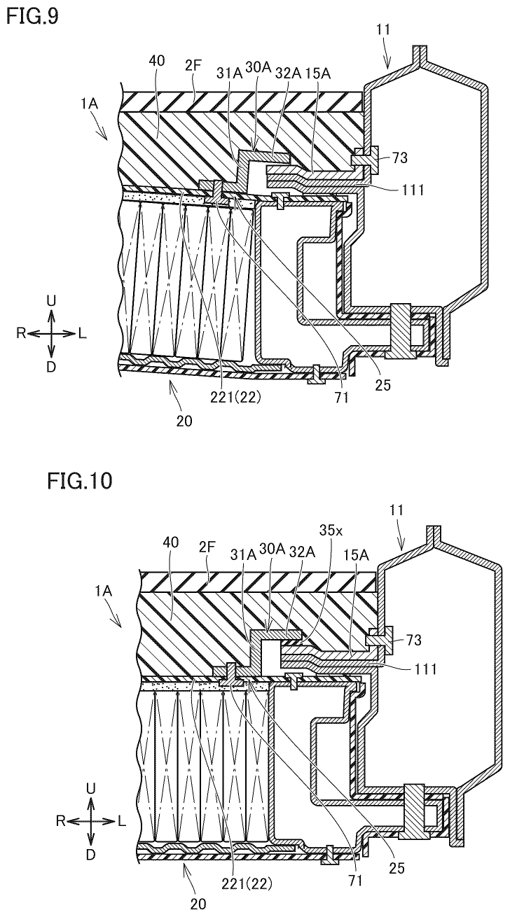

FIG. 9 is a cross-sectional view showing a state in which a power storage device has been deformed to warp upward in the vehicle lower structure according to the second embodiment. FIG. 9 shows a portion corresponding to a part of the portion shown in the cross-sectional view in FIG. 8.

As shown in FIGS. 8 and 9, also in the second embodiment, when stress acts on power storage device 20, fixation portion 25 (upper plate 221) tries to be deformed upward. At this time, supported member 30A (cantilever portion 32A) is displaced upward to move away from extending member 15A. As a result, power storage device 20 can be deformed to warp upward.

That is, also in the second embodiment, supported member 30A is fixed, whereby downward displacement of fixation portion 25 is suppressed. Supported member 30A is configured such that fixation portion 25 can be displaced upward.

In addition, also in the second embodiment, supported member 30A and extending member 15A do not necessarily need to be in direct contact with each other. FIG. 10 is a partial cross-sectional view showing a vehicle lower structure according to a modification of the second embodiment. FIG. 10 shows a portion corresponding to a part of the portion shown in the cross-sectional view in FIG. 8 in the second embodiment.

As shown in FIG. 10, supported member 30A may further have cushion member 35x disposed between cantilever portion 32A and extending member 15A.

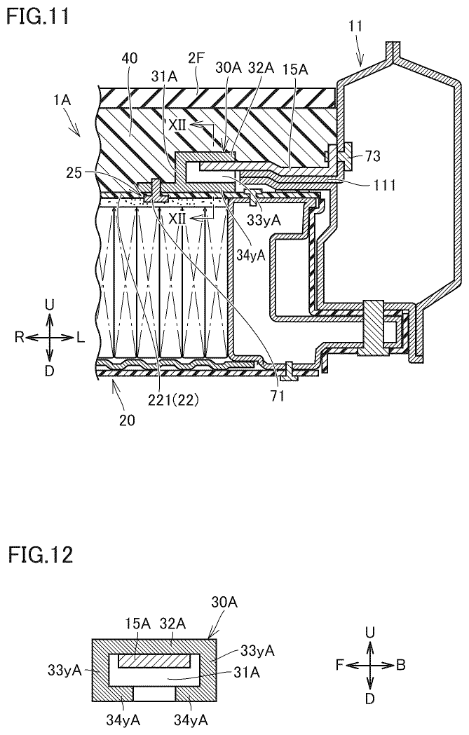

Furthermore, supported member 30A is not limited to the above-described configuration. FIG. 11 is a partial cross-sectional view showing a vehicle lower structure according to another modification of the second embodiment. FIG. 11 shows a portion corresponding to a part of the portion shown in the cross-sectional view in FIG. 8 in the second embodiment. FIG. 12 is a cross-sectional view of a part of the vehicle lower structure in FIG. 11 when viewed in the direction of an arrow XII-XII.

As shown in FIGS. 11 and 12, supported member 30A may further have a cover wall portion 33yA and a cover bottom portion 34yA. Cover wall portion 33yA extends downward from cantilever portion 32A. Cover wall portion 33yA covers a part of at least one side of the front side and the rear side of extending member 15A. Cover bottom portion 34yA extends in the substantially horizontal direction from cover wall portion 33yA. Cover bottom portion 34yA covers a part of the lower side of extending member 15A.

### Third Embodiment

Next, a vehicle lower structure according to a third embodiment of the present disclosure will be described. The vehicle lower structure according to the third embodiment of the present disclosure is different from vehicle lower structure 1 according to the first embodiment of the present disclosure mainly in terms of a configuration of a supported member. Description of the same configuration and effect as those of vehicle lower structure 1 according to the first embodiment will not be repeated.

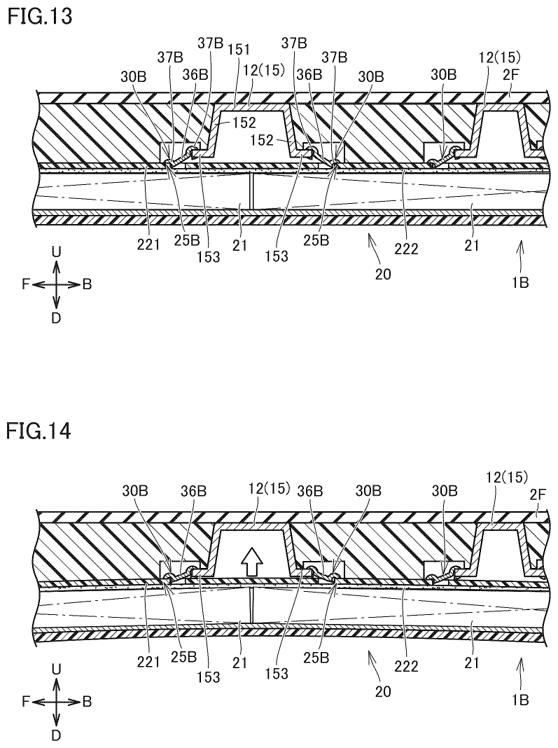

FIG. 13 is a cross-sectional view showing the vehicle lower structure according to the third embodiment. FIG. 13 shows a portion corresponding to the portion shown in FIG. 5 in the first embodiment. FIG. 14 is a cross-sectional view showing a state in which a power storage device has been deformed to warp upward in the vehicle lower structure according to the third embodiment. FIG. 14 shows a portion corresponding to the portion shown in the cross-sectional view in FIG. 13.

As shown in FIG. 13, in a vehicle lower structure 1B according to the third embodiment, a supported member 30B has a stretchable portion 36B. Stretchable portion 36B has a variable length. A fixation portion 25B is hung from extending member 15 by supported member 30B.

According to the above-described configuration, as shown in FIG. 14, stretchable portion 36B of supported member 30B contracts, whereby supported member 30B can permit power storage device 20 to be deformed to warp upward. That is, also in the third embodiment, supported member 30B is fixed, whereby downward displacement of fixation portion 25B is suppressed. Specifically, fixation portion 25 is hung by stretchable portion 36B that has already been extended to a prescribed length, whereby downward displacement of fixation portion 25B is suppressed. Supported member 30B is configured such that fixation portion 25B can be displaced upward.

Stretchable portion 36B may be configured to be stretchable because stretchable portion 36B is formed of a member made of a rubber material. Alternatively, stretchable portion 36B may be configured to be stretchable because stretchable portion 36B includes a rail member and a slider member that slides on the rail member.

Supported member 30B further has a pair of engagement portions 37B. The pair of engagement portions 37B are located at both ends of stretchable portion 36B. The pair of engagement portions 37B are engaged with fixation portion 25B (upper plate 221) and extending member 15 (protruding portion 153), respectively. Holes (not shown) for engagement of engagement portions 37B may, for example, be formed in fixation portion 25B (upper plate 221) and extending member 15 (protruding portion 153).

### Fourth Embodiment

Finally, a vehicle lower structure according to a fourth embodiment of the present disclosure will be described. The vehicle lower structure according to the fourth embodiment of the present disclosure is different from vehicle lower structure 1 according to the first embodiment of the present disclosure mainly in terms of a configuration of a supported member. Description of the same configuration and effect as those of vehicle lower structure 1 according to the first embodiment will not be repeated.

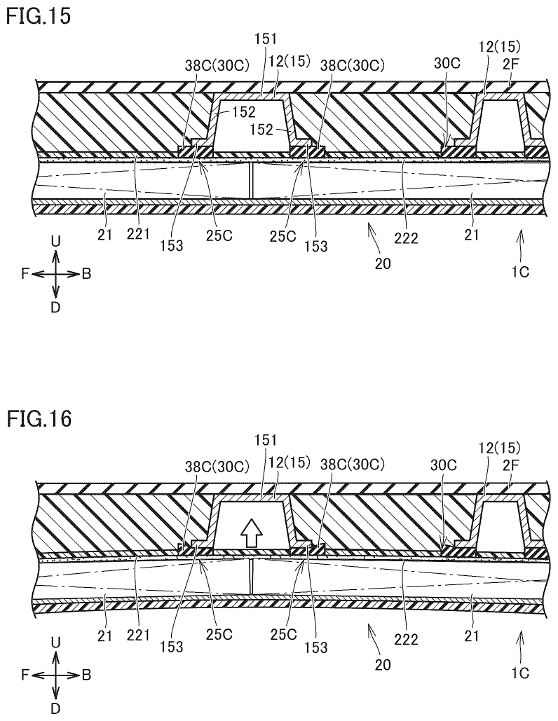

FIG. 15 is a cross-sectional view showing the vehicle lower structure according to the fourth embodiment. FIG. 15 shows a portion corresponding to the portion shown in FIG. 5 in the first embodiment. FIG. 16 is a cross-sectional view showing a state in which a power storage device has been deformed to warp upward in the vehicle lower structure according to the fourth embodiment. FIG. 16 shows a portion corresponding to the portion shown in the cross-sectional view in FIG. 15.

As shown in FIG. 15, in a vehicle lower structure 1C according to the present embodiment, a supported member 30C is formed of an elastic member 38C. Supported member 30C is sandwiched between a fixation portion 25C and extending member 15 in the up-down direction.

According to the above-described configuration, as shown in FIG. 16, supported member 30C is elastically deformed and compressed in the up-down direction, whereby supported member 30C can permit power storage device 20 to be deformed to warp upward. That is, also in the fourth embodiment, supported member 30C is fixed, whereby downward displacement of fixation portion 25C is suppressed. Specifically, fixation portion 25 is fixed to supported member 30C that has already been extended to a prescribed thickness by elastic deformation, whereby downward displacement of fixation portion 25C is suppressed. Supported member 30C is configured such that fixation portion 25C can be displaced upward.

Although fixation portion 25C is an upper portion of power storage module 21 in the fourth embodiment, fixation portion 25C may be upper plate 221. In the present embodiment, elastic member 38C is disposed in a hole formed in upper plate 221.

Elastic member 38C may be a rubber member, or may be a molded product made of a foaming resin. Elastic member 38C and extending member 15 (protruding portion 153) are joined to each other by an adhesive member, for example.

In the description of the above-described embodiments, the features that can be combined may be combined mutually.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A vehicle lower structure comprising:
a pair of side members;
an extending member extending from at least one of the pair of side members between the pair of side members;
a power storage device fixed to the pair of side members and disposed below the extending member; and
a supported member fixed to an upper portion of the power storage device and supported by the extending member, wherein
the power storage device includes a fixation portion to which the supported member is fixed such that downward displacement of the fixation portion is suppressed, and
the supported member is configured such that the fixation portion can be displaced upward.

2. The vehicle lower structure according to claim 1, wherein
the supported member includes:
a pillar portion extending upward from the fixation portion; and
a cantilever portion extending in a substantially horizontal direction from the pillar portion, and
the cantilever portion is supported from below by the extending member.

3. The vehicle lower structure according to claim 2, wherein
the supported member further includes a cushion member disposed between the cantilever portion and the extending member.

4. The vehicle lower structure according to claim 1, wherein
the extending member is a cross member extending from one side member to the other side member of the pair of side members.

5. The vehicle lower structure according to claim 2, wherein
the extending member extends from one side member of the pair of side members and is separated from the other side member of the pair of side members,
the pillar portion is disposed side by side with the extending member in a vehicle width direction, and
the cantilever portion extends along an upper surface of the extending member.

6. The vehicle lower structure according to claim 1, wherein
the supported member includes a stretchable portion having a variable length, and
the fixation portion is hung from the extending member by the supported member.

7. The vehicle lower structure according to claim 1, wherein
the supported member is formed of an elastic member, and
the supported member is sandwiched between the fixation portion and the extending member in an up-down direction.

8. The vehicle lower structure according to claim 2, wherein
the extending member is a cross member extending from one side member to the other side member of the pair of side members.

9. The vehicle lower structure according to claim 3, wherein
the extending member is a cross member extending from one side member to the other side member of the pair of side members.

10. The vehicle lower structure according to claim 5, wherein
the supported member further includes a cushion member disposed between the cantilever portion and the extending member.
